(19) United States
(12) Patent Application Publication
(10) Pub. No.: US 2025/0204338 A1
(43) Pub. Date: Jun. 26, 2025

(54) Modular Plant Irrigation System

(71) Applicant: Gordon J. Diehl, East Setauket, NY (US)

(72) Inventor: Gordon J. Diehl, East Setauket, NY (US)

(21) Appl. No.: 18/390,691

(22) Filed: Dec. 20, 2023

(51) Int. Cl. A01G 25/02; A01G 17/06; A01G 29/00

(52) U.S. Cl. CPC A01G 25/023; A01G 17/06; A01G 29/00

(57) ABSTRACT

A modular plant drip irrigation and fertilization system that is expandable, self-anchoring, flow-regulated, space-saving when in storage, biodegradable, scalable, and configurable for various plant types and sizes. It offers direct root feeding of fertilizer and supplements, suitable for hobby gardening and commercial agriculture.

### CROSS REFERENCE TO RELATED INVENTIONS

This application claims priority from application No. 63/492,445, a provisional application filed Mar. 27, 2023, entitled Modular Plant Irrigation System.

### FIELD OF INVENTION

The present invention relates to a modular plant drip irrigation and fertilization system that is expandable, self-anchoring, flow-regulated, space-saving when in storage, can be made of biodegradable materials, scalable, can be configured to provide direct root feeding of fertilizer and supplements, and can be used for hobby gardening as well as commercial agriculture.

### BACKGROUND OF THE INVENTION

Irrigation and fertilization are essential elements of plant growth, and various methods have been developed to optimize these processes. Drip irrigation and fertilization systems have been developed to provide an efficient and effective way to deliver water and nutrients directly to the plant roots, resulting in increased yields and reduced water consumption. However, current systems are often bulky, not eco-friendly, and not easily scalable to different sizes and types of plants. Additionally, current systems are not optimized for storage and transportation, which can be an issue for hobby gardeners and commercial farmers.

### SUMMARY OF THE INVENTION

The present invention provides a modular plant drip irrigation and fertilization system that addresses the above-mentioned issues. The system is space-saving when in storage, made of biodegradable materials, scalable, provides direct root feeding, and can be used for hobby gardening as well as commercial agriculture. The system is composed of individual modules that can be easily assembled to fit the specific needs of the plant or plants being grown. The modules consist of individual elements capable of being selectively interconnected in a manner that serves to provide a trellis-like structure which provides lateral and horizontal support for a developing plant, integral drip irrigation features, and a terminus that firmly anchors the entire structure, permitting concurrently the measured delivery of water and nutrients directly to a plant's roots, and modular clip elements that connect the modules together to create a larger system.

The structural elements of the invention can be made of any material that is sufficiently structurally rigid, environmentally friendly and decomposes over time. This makes the system a sustainable choice for gardening and farming. The device and constituent components thereof is designed to be space-saving when not in use, as all parts can be easily collapsed and stored.

The drip irrigation and fertilization tube is designed to deliver water and nutrients directly to the roots of the plant, resulting in increased yields.

In the preferred embodiment, the tubular individual vertical components may include at one end an integrated coupling or interconnection point for adding additional vertical components to achieve a desired height, and also to create a point for interconnecting horizontal components, or spars.

In another embodiment, the interconnection points may be achieved by means of an independent coupling which is capable of connecting simple, tubular vertical components without an integrated interconnection point (not depicted).

### BRIEF DESCRIPTION OF THE DRAWINGS

The following drawings are attached in explanation of the invention, the features of which are referenced within the detailed description of the invention. Elements in the drawing figures are not necessarily drawn to scale. Note that although the example presented of the invention is generally triangular as illustrated throughout the following drawings, said shape may be of any practicable multi-sided geometry suitable for providing the completed structure. Individual units may be interlinked in various combinations deemed suitable by the grower, allowing for limitless scaling of the layout.

FIG. 1: This figure presents a view of the vertical structural elements (10) of the invention, and also shows in greater detail a cross-section of the terminal portion of an individual vertical member (20), specifically depicting the interconnection points (15) for creating lateral support.

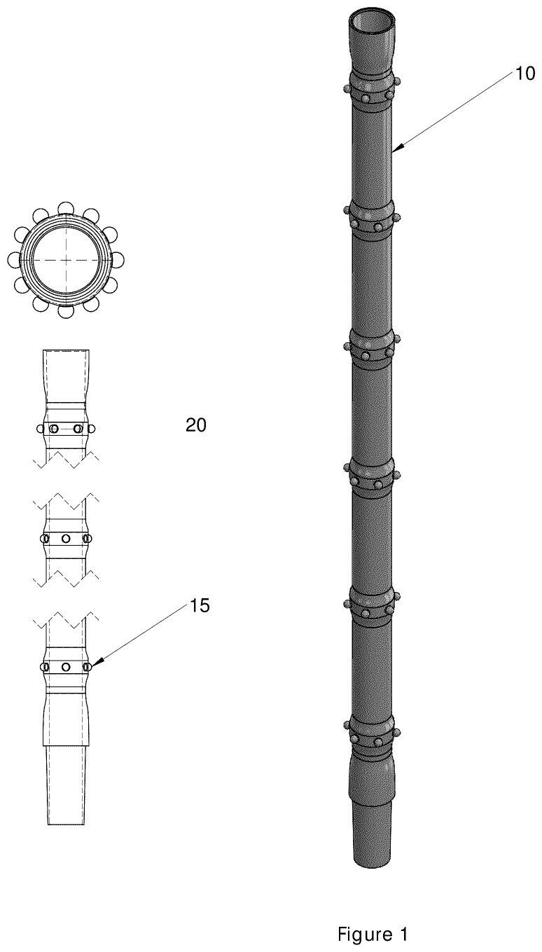

FIG. 2: This figure presents a side view of the sub-grade base, or anchor component (30) of the invention's vertical components. The anchor may be driven into soil or any other suitable substrate, and as is clearly depicted, bears perforations (35), which may be of any sized diameter deemed suitable by a grower for purposes of permitting directed irrigation water and any desired nutrients to permeate in a very controlled manner into the soil and consequently supply a growing plant with all needs. Also shown in greater detail is the cross-section (38) of the anchor component, which varies from the remaining horizontal elements.

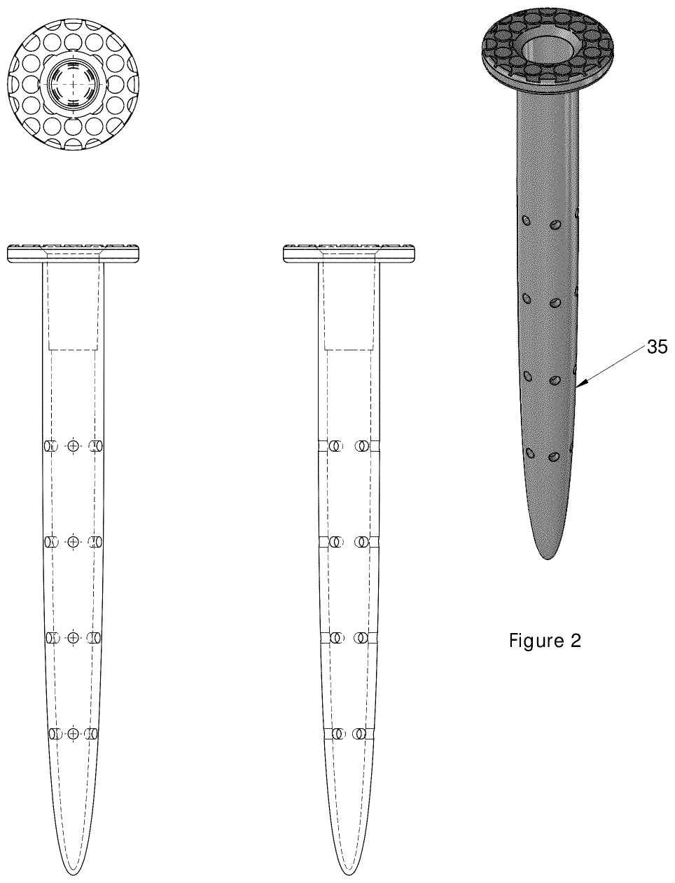

FIG. 3: This figure is a side view of the horizontal spar (40) used to connect the vertical components of the invention, providing both structural rigidity as well as attachment points for plants irrigated and fed by the system. A close-up view of the profile of the spar is shown in detail, with the detent channel (45) depicted being intended to mate with the projecting interconnection points, depicted in FIG. 1 but not shown here, on the vertical elements to ensure a solid interconnection.

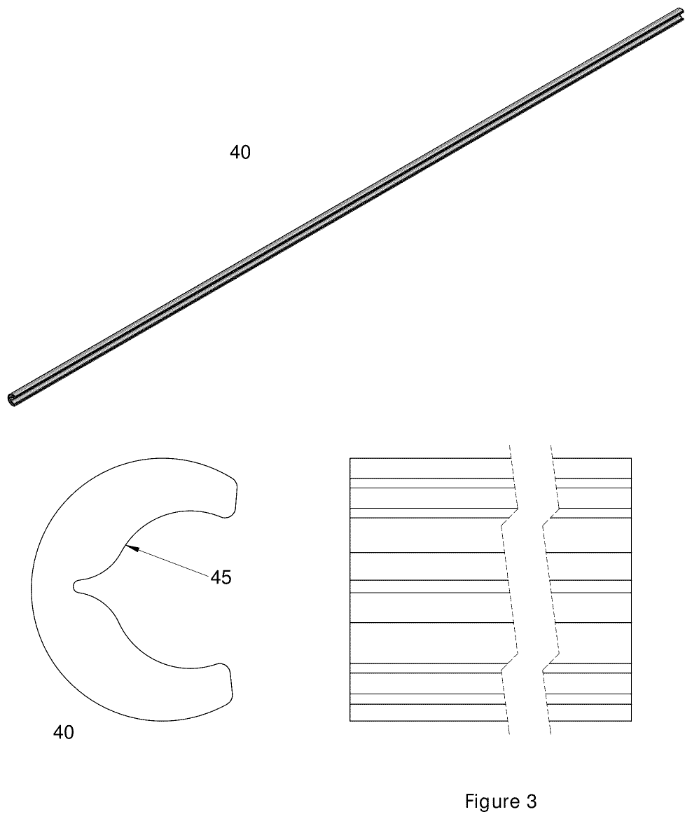

FIG. 4: This figure presents a view in greater detail of the vertical structural elements of the invention, showing particularly how individual sections can be interconnected.

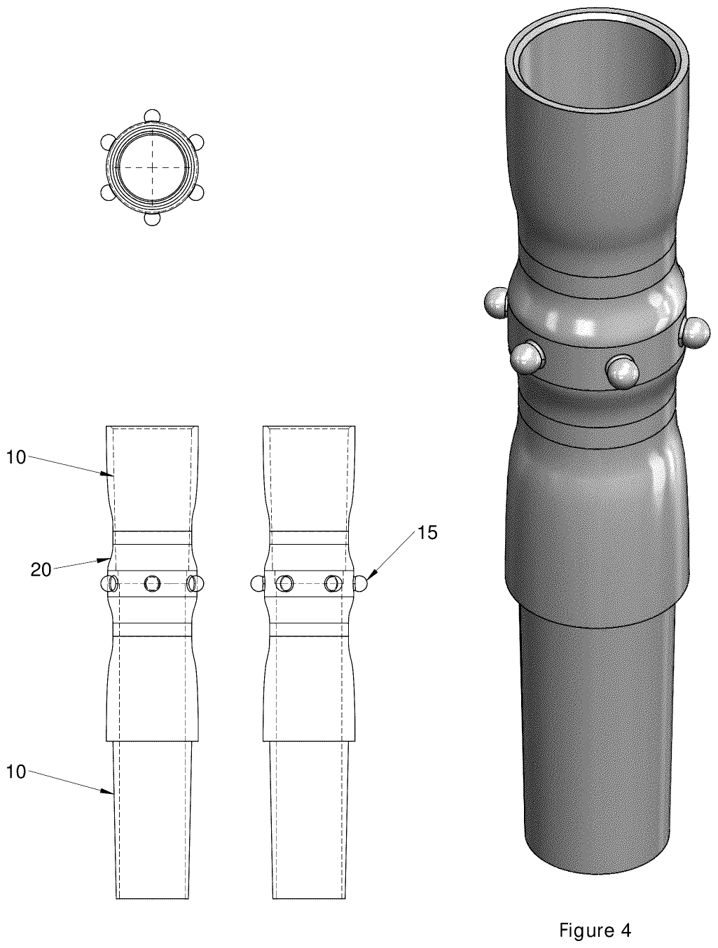

FIG. 5: This figure is a top-angle view of the vertical funnel element (15) of the invention into which water for irrigation and any nutrients may be introduced into sections of the completed system. This funnel-like element mates seamlessly with all other vertical components.

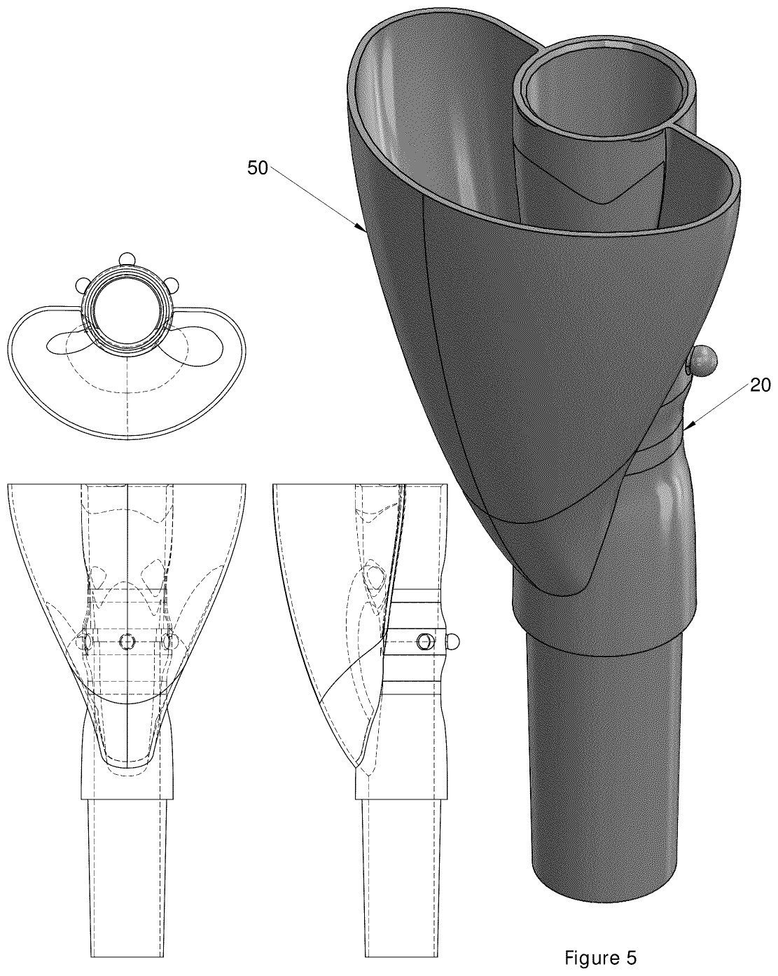

FIG. 6: This figure is a side view of a completed assembly of the invention.

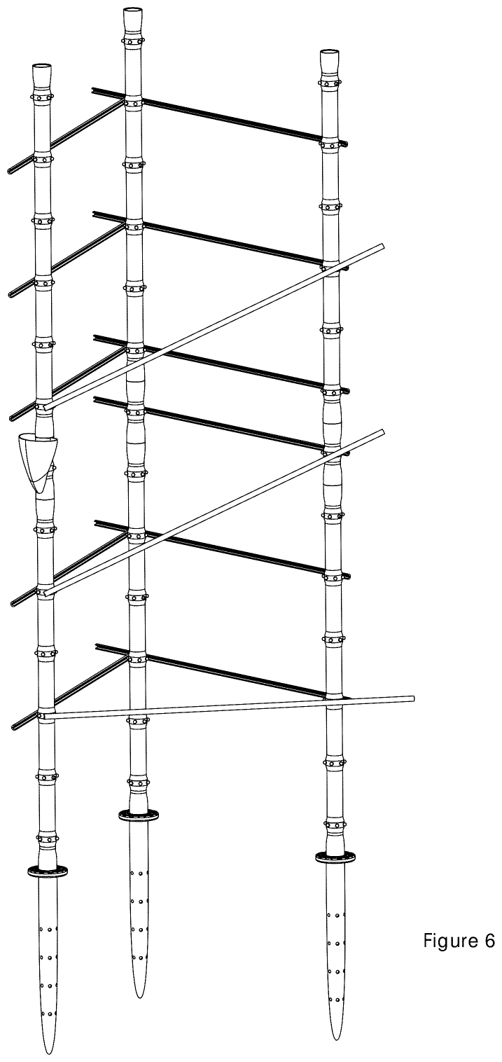

### DETAILED DESCRIPTION OF THE INVENTION

The modular plant drip irrigation and fertilization system comprises individual horizontal and vertical components that can be assembled into constituent modules capable of both supporting—in the manner of a trellis—and irrigating growing plants. The modules can be seamlessly interconnected into assemblies that can be added to successively to form a larger system. Assembled modules can be interconnected to create plant rows, or clusters, as is desirable to the grower. Importantly, each module consists of interconnectable elements that provide flexible—in the sense of layout—and rigid (in terms of structural stability) lateral and horizontal support for the plant, as well as a terminus that firmly anchors the entire structure to the ground by means of a hollow base spike bearing a series of perforations to allow water and soluble plant nutrients to be introduced to a funnel-like opening on a module's vertical section. The modules can be easily connected using projecting clip elements radiating from the vertical components at regular intervals and interconnected with paired horizontal rail components.

The structural elements of the invention can be made of a biodegradable material, such as a bioplastic, making the system environmentally friendly and sustainable. The final assembly and constituent parts are designed to be space-saving when not in use, as all parts can be easily collapsed and stored, or disassembled partially or in their entirety. Moreover, when made with biodegradable materials, at the end of a growing cycle, components may be left in place to compost and enrich the soil.

The drip irrigation and fertilization tube that is at the heart of the invention is designed to deliver water and nutrients directly to the roots of the plant, resulting in increased yields and for less waste of resources as composed to most other means of loss-directed irrigation and fertilization. Importantly, the system is scalable, making it suitable for both hobby gardening and commercial agriculture.

What is claimed is:

1: A modular plant drip irrigation and fertilization system comprising individual modules, each module comprising interconnectable components that provide lateral and horizontal support for a plant, a terminus that firmly anchors the entire structure to the ground, and an integrated drip irrigation and fertilization tube configured to deliver water and nutrients directly to the roots of the plant.

2: The modular plant drip irrigation and fertilization system of claim 1, wherein the interconnectable components of each module are selectively interconnected to form a trellis-like structure.

3: The modular plant drip irrigation and fertilization system of claim 1, wherein the interconnectable components of each module are composed of a biodegradable material, rendering the system environmentally friendly and sustainable.

4: The modular plant drip irrigation and fertilization system of claim 1, further comprising modular clip components for connecting the individual modules, thereby creating a larger integrated system.

5: The modular plant drip irrigation and fertilization system of claim 1, wherein the terminus of each module anchors the structure to the ground while allowing the measured delivery of water and nutrients directly to the plant's roots.

6: The modular plant drip irrigation and fertilization system of claim 1, wherein the structural components of the system are collapsible, allowing for space-saving storage when not in use.

7: The modular plant drip irrigation and fertilization system of claim 1, wherein the drip irrigation and fertilization tube is scalable, adapting the system for use in both hobby gardening and commercial agriculture.

8: The modular plant drip irrigation and fertilization system of claim 1, wherein the individual modules are configured to be easily assembled and disassembled, facilitating customization according to the specific needs of the plant or plants being grown.

9: The modular plant drip irrigation and fertilization system of claim 1, wherein the drip irrigation and fertilization tube is designed to increase yields by delivering water and nutrients directly to the roots of the plant.

10: The modular plant drip irrigation and fertilization system of claim 1, wherein the system is scalable to different sizes and types of plants, making it versatile for a variety of plant cultivation applications.

11: The modular plant drip irrigation and fertilization system of claim 1, wherein the vertical components may feature an integrated interconnection point for the addition of other vertical components as well as connection to lateral components.

12: The modular plant drip irrigation and fertilization system of claim 1, wherein the vertical components may be simple, tubular sections which can be interconnected by an individual coupling which also serves to connect to horizontal components.
